(19) United States
(12) Patent Application Publication
(10) Pub. No.: US 2010/0058354 A1
(43) Pub. Date: Mar. 4, 2010

(54) ACCELERATION OF MULTIMEDIA PRODUCTION

(76) Inventors: Gene Fein, Malibu, CA (US); Edward Merritt, Lenox, MA (US)

Correspondence Address: FOLEY & LARDNER LLP, 150 EAST GILMAN STREET, P.O. BOX 1497, MADISON, WI, 53701-1497, US

(21) Appl. No.: 12/200,477

(22) Filed: Aug. 28, 2008

(51) Int. Cl. G06F 9/44

(52) U.S. Cl. 719/313

(57) ABSTRACT

A device includes a processor and a computer-readable medium including computer-readable instructions. Upon execution by the processor, the computer-readable instructions cause the device to receive a first request from a second device, where the first request includes edited multimedia content to be rendered by a third device. The computer-readable instructions also cause the device to provide a second request to the third device, where the second request includes the edited multimedia content. The computer-readable instructions also cause the device to receive rendered multimedia content from the third device, where the rendered multimedia content corresponds to the edited multimedia content. The computer-readable instructions further cause the device to provide the rendered multimedia content to the second device.

### BACKGROUND

Multimedia can be created in various stages. For example, in the context of a multimedia video, one stage can be preparation. During the preparation stage, a script can be created, one or more sets can be built, actors/actresses can be signed, etc. Another stage in multimedia video creation can be the capture of raw multimedia content. The raw multimedia content can be film segments of actors/actresses performing a role based on the script. Another stage can be editing of the film segments. Editing of the film segments can include adding animation to a film segment, removing unwanted footage from a film segment, adding music or other audio to a film segment, speeding up or slowing down the playback time of a film segment, etc. Another stage in the creation of a multimedia video can be rendering. Rendering can refer to application of the edits to the film segments to generate a finished product. The rendering process can be performed upon completion of all edits, or intermittently throughout the editing process. If performed on a computer, the rendering process can utilize significant processing power.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a block diagram of a multimedia production acceleration system in accordance with an illustrative embodiment.

FIG. 2 depicts a block diagram of a user computing device of the multimedia production acceleration system of FIG. 1 in accordance with an illustrative embodiment.

FIG. 3 depicts a block diagram of a middleware system of the multimedia production acceleration system of FIG. 1 in accordance with an illustrative embodiment.

FIG. 4 depicts a block diagram of a cloud computing system of the multimedia production acceleration system of FIG. 1 in accordance with an illustrative embodiment.

FIG. 5 depicts a flow diagram illustrating operations performed by the cloud computing system of FIG. 4 in accordance with an illustrative embodiment.

FIG. 6 depicts a flow diagram illustrating operations performed by the user computing device of FIG. 2 in accordance with an illustrative embodiment.

FIG. 7 depicts a flow diagram illustrating operations performed by the middleware system of FIG. 3 in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Illustrative systems, methods, devices, computer-readable media, etc. are described for accelerating multimedia production. In an illustrative embodiment, multimedia production can be accelerated using a middleware system and a cloud computing system. The middleware system, which can be used in part to facilitate communication between the cloud computing system and a user computing device, can receive multimedia content and/or edits to the multimedia content from the user computing device. The middleware system can provide the multimedia content and/or edits to the cloud computing system. The cloud computing system can render the multimedia and provide the rendered multimedia to the middleware system. The middleware system can provide the rendered multimedia to the user computing device. As such, the cloud computing system can be used to perform the processor intensive rendering and reduce the computing burden of the user computing device.

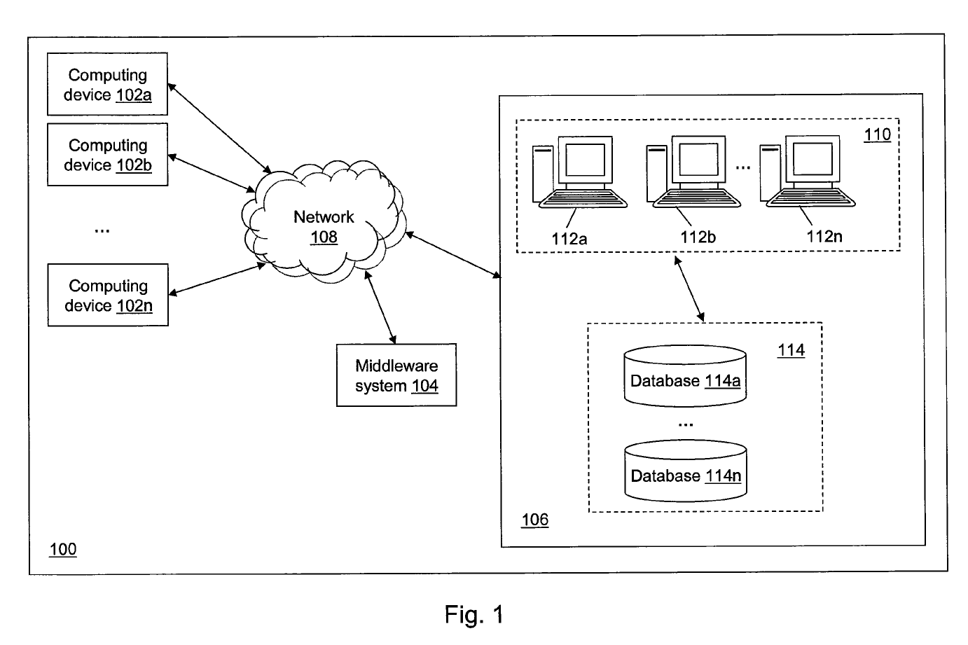

With reference to FIG. 1, a block diagram of a multimedia production acceleration system 100 is shown in accordance with an illustrative embodiment. Multimedia production acceleration system 100 can include one or more user computing devices 102a, 102b, . . . , 102n, a middleware system 104, and a cloud computing system 106. The one or more user computing devices 102a, 102b, . . . , 102n may be a computer of any form factor including a laptop, a desktop, a server, an integrated messaging device, a personal digital assistant, a cellular telephone, an iPod, etc. The devices associated with the one or more user computing devices 102a, 102b, . . . , 102n, middleware system 104, and cloud computing system 106 may communicate with each other using a network 108.

Network 108 may include one or more type of network including a cellular network, a peer-to-peer network, the Internet, a local area network, a wide area network, a Wi-Fi network, a Bluetooth™ network, etc. Cloud computing system 106 can include one or more servers 110 and one or more databases 114. A cloud computing system refers to one or more computational resources accessible over a network to provide users on-demand computing services. The one or more servers 110 can include one or more computing devices 112a, 112b, . . . , 112n which may be computers of any form factor. The one or more databases 114 can include a first database 114a, . . . , and an nth database 114n. The one or more databases 114 can be housed on one or more of the one or more servers 110 or may be housed on separate computing devices accessible by the one or more servers 110 directly through wired or wireless connection or through network 108. The one or more databases 114 may be organized into tiers and may be developed using a variety of database technologies without limitation. The components of cloud computing system 106 may be implemented in a single computing device or a plurality of computing devices in a single location, in a single facility, and/or may be remote from one another.

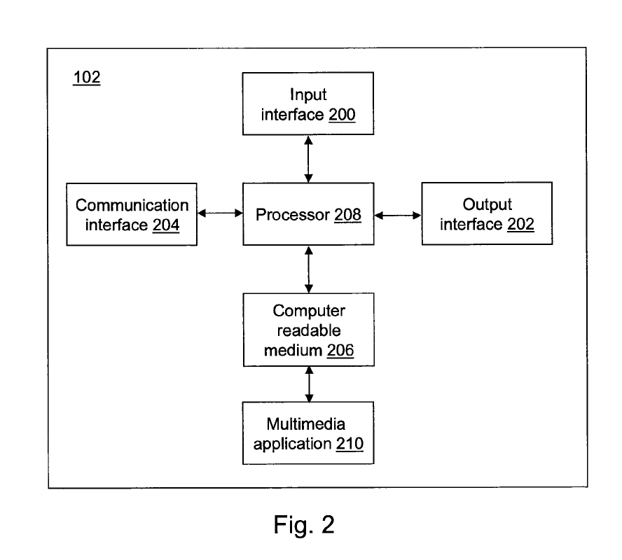

With reference to FIG. 2, a block diagram of a user computing device 102 of multimedia production acceleration system 100 is shown in accordance with an illustrative embodiment. User computing device 102 can include an input interface 200, an output interface 202, a communication interface 204, a computer-readable medium 206, a processor 208, and a multimedia application 210. Different and additional components may be incorporated into user computing device 102 without limitation. Multimedia application 210 provides a graphical user interface with user selectable and controllable functionality. Multimedia application 210 may include a browser application or other user interface based application that interacts with middleware system 104 to allow a user to provide multimedia content for storage, to receive stored multimedia content, to access one or more editing application, to make and/or provide edits to multimedia content, and/or to submit a request for the rendering of edited multimedia content.

Input interface 200 provides an interface for receiving information from the user for entry into user computing device 102 as known to those skilled in the art. Input interface 200 may interface with various input technologies including, but not limited to, a keyboard, a pen and touch screen, a mouse, a track ball, a touch screen, a keypad, one or more buttons, etc. to allow the user to enter information into user computing device 102 or to make selections presented in a user interface displayed using a display under control of multimedia application 210. Input interface 104 may provide both an input and an output interface. For example, a touch screen both allows user input and presents output to the user. User computing device 102 may have one or more input interfaces that use the same or a different interface technology.

Output interface 202 provides an interface for outputting information for review by a user of user computing device 102. For example, output interface 202 may include an interface to a display, a printer, a speaker, etc. The display may be any of a variety of displays including, but not limited to, a thin film transistor display, a light emitting diode display, a liquid crystal display, etc. The printer may be any of a variety of printers including, but not limited to, an ink jet printer, a laser printer, etc. User computing device 102 may have one or more output interfaces that use the same or a different interface technology.

Communication interface 204 provides an interface for receiving and transmitting data between devices using various protocols, transmission technologies, and media. The communication interface may support communication using various transmission media that may be wired or wireless. User computing device 102 may have one or more communication interfaces that use the same or different protocols, transmission technologies, and media.

Computer-readable medium 206 is an electronic holding place or storage for information so that the information can be accessed by processor 208. Computer-readable medium 206 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disk (CD), digital versatile disk (DVD), . . . ), smart cards, flash memory devices, etc. User computing device 102 may have one or more computer-readable media that use the same or a different memory media technology. User computing device 102 also may have one or more drives that support the loading of a memory media such as a CD, a DVD, a flash memory card, etc.

Processor 208 executes instructions as known to those skilled in the art. The instructions may be carried out by a special purpose computer, logic circuits, or hardware circuits. Thus, processor 208 may be implemented in hardware, firmware, software, or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with input interface 200, with output interface 202, with communication interface 204, and with computer-readable medium 206 to receive, to send, and to process information. Processor 208 may retrieve a set of instructions from a permanent memory device and copy the instructions in an executable form to a temporary memory device that is generally some form of RAM. User computing device 102 may include a plurality of processors that use the same or a different processing technology.

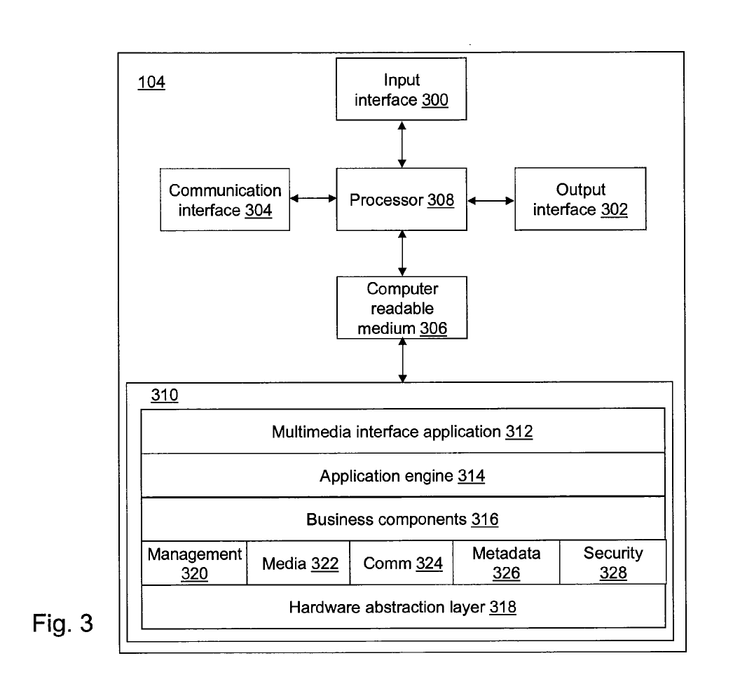

With reference to FIG. 3, a block diagram of middleware system 104 of multimedia production acceleration system 100 is shown in accordance with an illustrative embodiment. Middleware system 104 can include an input interface 300, an output interface 302, a communication interface 304, a computer-readable medium 306, a processor 308, and multimedia architecture 310. Different and additional components may be incorporated into middleware system 104 without limitation. For example, middleware system 104 may include a database that is directly accessible by middleware system 104 or accessible by middleware system 104 using a network. Middleware system 104 may further include a cache for temporarily storing information communicated to middleware system 104. Input interface 300 provides similar functionality to input interface 200. Output interface 302 provides similar functionality to output interface 202. Communication interface 304 provides similar functionality to communication interface 204. Computer-readable medium 306 provides similar functionality to computer-readable medium 206. Processor 308 provides similar functionality to processor 208.

Multimedia architecture 310 can include a multimedia interface application 312, an application engine 314, business components 316, and a hardware abstraction layer 318. Multimedia interface application 312 includes the operations associated with interfacing between cloud computing system 106 and user computing device 102 to maintain and organize multimedia content and edits, to process a request for rendering edited multimedia content, and to provide stored multimedia content and/or rendered multimedia content to user computing device 102. Multimedia architecture 310 includes functionality to support rendering requests of content, such as animations, compositing, and effects, editing requests, compiling requests, audio selection and playback requests, commands to distribute to other users, commands to distribute to other devices, mastering into numerous final output formats, output by acts, output by time code segment, revised script translation transcript due to edits via a dragon systems type of voice recognition to text technology, revised music rundowns and cue sheets, along with feedback/editorial commentary/suggestions input and requests, as well as a list function of all past and present requests and total edit requests to form a master edit record, etc. Based on these past requests and the analysis of the current composition, for example, twelve acts where eight have been edited and rendered, multimedia architecture 310 may query the user about future tasks, based upon a logical evaluation of what is left to do using a scan of the materials remaining to be edited that are either scanned into multimedia production acceleration system 100 or existing only as lists in multimedia production acceleration system 100. Business components 316 include a running cost analysis based upon usage of a third party rendering system if that cost is based on a pay as you go type system, an a la carte system, or based upon payment for resources used up to a certain storage or hours limit utilizing certain processing power, or utilizing the system to transfer information between and among parties.

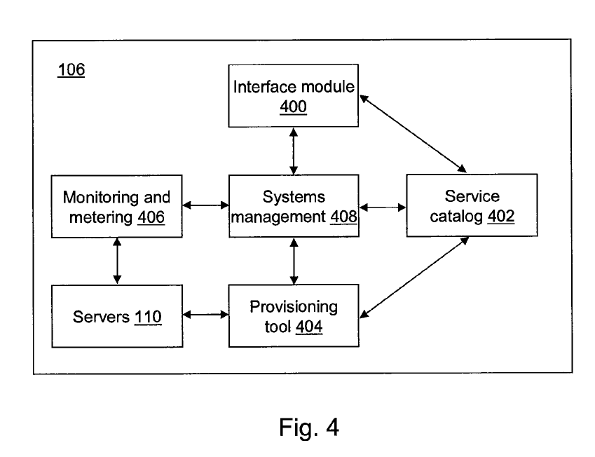

With reference to FIG. 4, a block diagram of modules associated with cloud computing system 106 of multimedia production acceleration system 100 is shown in accordance with an illustrative embodiment. Cloud computing system 106 can include an interface module 400, a service catalog 402, a provisioning tool 404, a monitoring and metering module 406, a system management module 408, and the one or more servers 110. Different and additional components may be incorporated into cloud computing system 106 without limitation. For example, cloud computing system 106 may further include the one or more databases 114. Middleware system 104 interacts with interface module 400 to request services. Service catalog 402 provides a list of services that middleware system 104 can request. Provisioning tool 404 allocates computational resources from the one or more servers 110 and the one or more databases 114 to provide the requested service and may deploy edited multimedia content for rendering at the one or more servers 110. Monitoring and metering module 406 tracks the usage of the one or more servers 110 so the resources used can be attributed to a certain user possibly for billing purposes. System management module 408 manages the one or more servers 110. The one or more servers 110 can be interconnected as if in a grid running in parallel.

Interface module 400 may be configured to allow selection of a service from service catalog 402. A request associated with a selected service may be sent to system management module 408. System management module 408 identifies an available resource(s) such as one or more of servers 110 and/or one or more of databases 114. System management module 408 calls provisioning tool 404 to allocate the identified resource(s). Provisioning tool 404 may deploy a requested stack or web application as well.

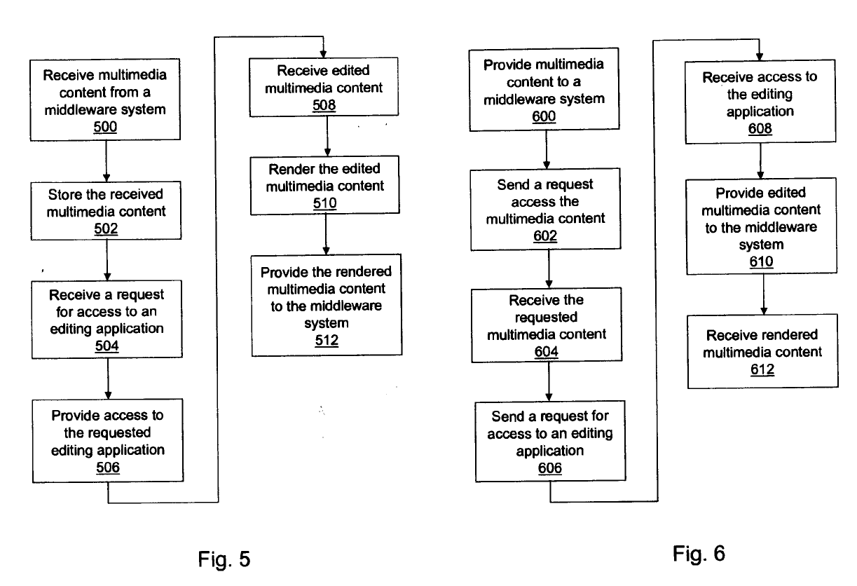

With reference to FIG. 5, illustrative operations performed by cloud computing system 106 are described. Additional, fewer, or different operations may be performed, depending on the embodiment. The order of presentation of the operations of FIG. 5 is not intended to be limiting. In an operation 500, multimedia content is received from middleware system 104. The received multimedia content can be video content, audio content, audiovisual content, etc. In an illustrative embodiment, the received multimedia content can be raw footage of audiovisual content. In an operation 502, the received multimedia content is stored. The received multimedia content can be stored in the one or more databases 114, or in any other storage location accessible by cloud computing system 106. In an alternative embodiment, the multimedia content may be stored by middleware system 104, and may not be provided to cloud computing system 106.

In an operation 504, a request for access to an editing application is received from middleware system 104. In an operation 506, access to the requested editing application is provided. Access to the requested editing application can be provided to middleware system 104 for eventual provision to a user computing system that has requested the editing application. As such, movie editors and other end users can perform on set editing with a mobile or other user computing device. In an illustrative embodiment, the editing application can provide any editing functionality known to those of skill in the art. In another illustrative embodiment, cloud computing system 106 can support a variety of different editing applications to suit the needs of different end users. In an alternative embodiment, the editing application(s) may be maintained and provided by middleware system 104. In another alternative embodiment, the editing application(s) may reside on user computing device 102.

In an operation 508, edited multimedia content is received from middleware system 104. The edited multimedia content can correspond to multimedia content that is stored in operation 502. Alternatively, the edited multimedia content may correspond to multimedia content that has not previously been provided to cloud computing system 106. Edits to the multimedia content can include the addition or manipulation of credits, the addition or manipulation of graphics, the addition or manipulation of animation, the removing of unwanted portions of audiovisual segments, the addition or manipulation of music or other audio content, the adjustment of playback speed of the multimedia content, the addition or manipulation of transitions between scenes, the addition or manipulation of special effects, and/or any other types of edits known to those of skill in the art.

In an operation 510, the edited multimedia content is rendered by cloud computing system 106. Rendering can refer to application of the edits to the multimedia content, compiling of multimedia content segments, etc. to generate a partial or complete end product. Rendering can also refer to the addition, reduction, or manipulation of shading, texture, lighting, shadows, reflections, transparency, caustics, blur, depth perception, etc. to improve the quality of the multimedia content. Cloud computing system 106 may render the edited multimedia content according to any method known to those of skill in the art. In an operation 512, the rendered multimedia content is provided to middleware system 104 for eventual provision to user computing device 102.

With reference to FIG. 6, illustrative operations performed by user computing device 102 are described. Additional, fewer, or different operations may be performed, depending on the embodiment. The order of presentation of the operations of FIG. 6 is not intended to be limiting. In an operation 600, multimedia content is provided to middleware system 104. In an illustrative embodiment, the multimedia content can be provided for storage on middleware system 104 and/or cloud computing system 106. In an operation 602, a request to access the multimedia content is sent from user computing device 102 to middleware system 104. In an operation 604, the requested media content is received from middleware system 104. In an alternative embodiment, the multimedia content may be stored locally on computer readable medium 206 of user computing device 102 or at another location.

In an operation 606, a request for access to an editing application is sent to middleware system 104. In an operation 608, access to the requested editing application is received. In an illustrative embodiment, access to the requested editing application can be received through multimedia application 210, which can be in communication with middleware system 104. In an alternative embodiment, one or more editing application may be installed and maintained locally on user computing device 102. In an operation 610, edited multimedia content is provided to middleware system 104 for eventual rendering. The edited multimedia content can include one or more portions of an entire multimedia production such that the rendering is done in stages, or the entire multimedia production such that all of the rendering is completed at once. In an operation 612, rendered multimedia content is received from middleware system 104.

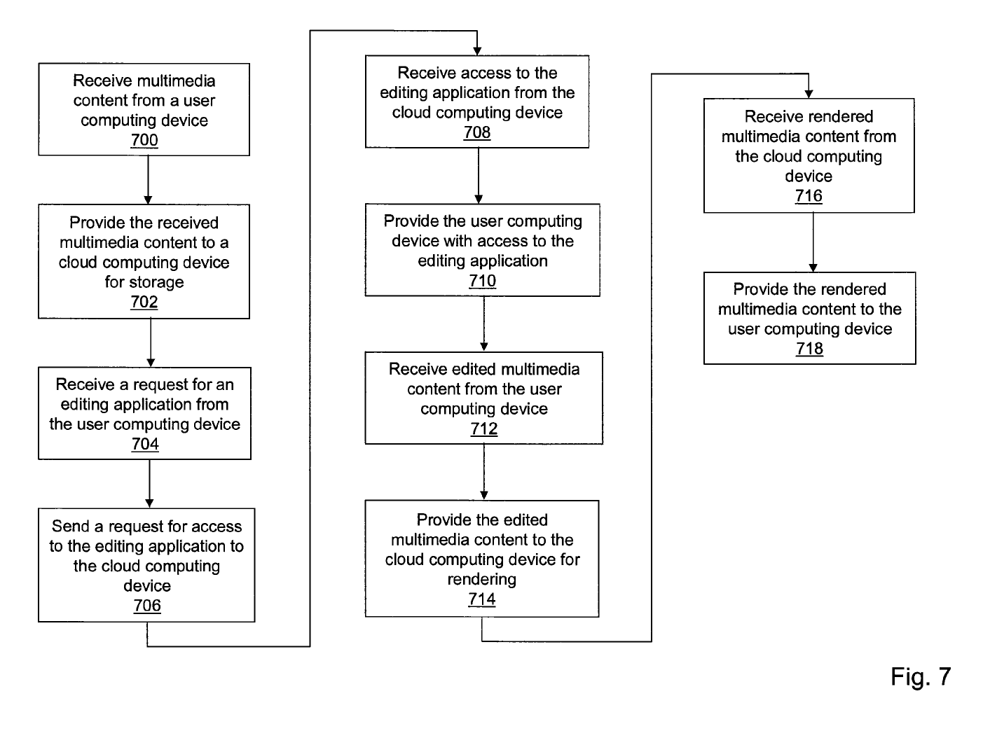

With reference to FIG. 7, illustrative operations performed by middleware system 104 are described. Additional, fewer, or different operations may be performed, depending on the embodiment. The order of presentation of the operations of FIG. 7 is not intended to be limiting. Middleware system 104 defines the parameters for returning multimedia content, rendered multimedia content, editing application access, etc. to computing device 102 using application programming interfaces, for example associated with operating system compatibility, display capability, media player capability, etc. Middleware system 104 further defines similar parameters for interacting with cloud computing system 106.

In an operation 700, multimedia content is received from user computing device 102. In an operation 702, the received multimedia content is provided to cloud computing system 106 for storage. Alternatively, the received multimedia content may be stored locally at middleware system 104. In an operation 704, a request for an editing application is received from user computing device 102. In an operation 706, a request for access to the requested editing application is sent to cloud computing system 106, and in an operation 708, access to the requested application is received from cloud computing system 106. In an operation 710, user computing device 102 is provided with access to the requested editing application. In an alternative embodiment, one or more editing application may reside locally at middleware system 104.

In an operation 712, edited multimedia content is received from user computing device 102. In an operation 714, the edited multimedia content is provided to cloud computing system 106 for rendering. In an operation 716, rendered multimedia content is received from cloud computing system 106, and in an operation 718, the rendered multimedia content is provided to user computing device 102.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device comprising:
a processor; and
a computer-readable medium including computer-readable instructions that, upon execution by the processor, cause the device to
receive a first request from a second device, wherein the first request includes edited multimedia content to be rendered by a third device;
provide a second request to the third device, wherein the second request includes the edited multimedia content;
receive rendered multimedia content from the third device, wherein the rendered multimedia content corresponds to the edited multimedia content; and
provide the rendered multimedia content to the second device.

2. The device of claim 1, wherein the computer-readable instructions further cause the device to:
receive a third request for access to an editing application from the second device;
provide a fourth request to the third device for access to the editing application;
receive access to the editing application from the third device; and
provide the second device with access to the editing application.

3. The device of claim 2, wherein the edited multimedia content is edited using the editing application.

4. The device of claim 1, further comprising a multimedia interface application configured to provide an interface between the device and the second device and between the device and the third device.

5. The device of claim 4, wherein the second device uses a first operating system and the third device uses a second operating system.

6. The device of claim 1, wherein the computer-readable instructions further cause the device to receive a third request from the second device, wherein the third request includes multimedia content to be stored.

7. The device of claim 6, wherein the computer-readable instructions further cause the device to provide the multimedia content to the third device for storage.

8. The device of claim 6, wherein the computer-readable instructions further cause the device to store the multimedia content locally at the device.

9. The device of claim 6, wherein the edited multimedia content corresponds to the multimedia content.

10. A system comprising:
a first device comprising
a first processor; and
a first computer-readable medium including first computer-readable instructions that, upon execution by the first processor, cause the first device to
receive a first request from a second device, wherein the first request includes edited multimedia content to be rendered by a third device;
provide a second request to the third device, wherein the second request includes the edited multimedia content;
receive rendered multimedia content from the third device, wherein the rendered multimedia content corresponds to the edited multimedia content; and
provide the rendered multimedia content to the second device; and
the third device comprising
a second processor; and
a second computer-readable medium including second computer-readable instructions that, upon execution by the second processor, cause the third device to
receive the second request from the first device;
render the edited multimedia content to generate the rendered multimedia content; and
provide the rendered multimedia content to the first device.

11. The system of claim 10, wherein the second computer-readable instructions further cause the third device to:
receive a third request from the first device, wherein the third request includes second edited multimedia content;
render the second edited multimedia content to generate second rendered multimedia content;
combine the rendered multimedia content and the second rendered multimedia content to generate an audiovisual production; and
provide the audiovisual production to the first device.

12. The system of claim 10, wherein the second computer-readable instructions further cause the third device to:
receive a third request for access to an editing application from the first device; and
provide the first device with access to the editing application.

13. The system of claim 12, wherein the first computer-readable instructions further cause the first device to provide the second device with access to the editing application.

14. The system of claim 12, wherein the edited multimedia content is edited on the second device with the editing application.

15. The system of claim 10, wherein the second computer-readable instructions further cause the third device to:
receive multimedia content from the first device; and
store the received multimedia content.

16. A method of accelerating multimedia production, the method comprising:
receiving a first request at a first device from a second device, wherein the first request includes edited multimedia content;
providing a second request from the first device to a third device, wherein the second request includes the edited multimedia content;
receiving rendered multimedia content from the third device at the first device, wherein the rendered multimedia content corresponds to the edited multimedia content; and
providing the rendered multimedia content to the second device.

17. The method of claim 15, further comprising:
receiving a third request at the first device from the second device, wherein the third request is for access to an editing application;
providing a fourth request from the first device to the third device, wherein the fourth request is for access to the editing application;
receiving access to the editing application from the third device; and
providing the second device with access to the editing application.

18. The method of claim 17, wherein the edited multimedia content is edited at the second device using the editing application.

19. The method of claim 15, further comprising using a multimedia interface application to interact with the second device and with the third device, wherein the second device uses a first operating system and the third device uses a second operating system.

20. The method of claim 15, further comprising:
receiving multimedia content at the first device from the second device; and
storing the received multimedia content.
